(19) United States
(12) Patent Application Publication
(10) Pub. No.: US 2013/0322842 A1
(43) Pub. Date: Dec. 5, 2013

(54) ELECTRONIC DEVICE AND DATA TRANSFER METHOD

(71) Applicant: KABUSHIKI KAISHA TOSHIBA, Tokyo (JP)

(72) Inventors: Tomonori SAKAGUCHI, Hamura-shi (JP); Jun OHASHI, Ome-shi (JP)

(73) Assignee: KABUSHIKI KAISHA TOSHIBA, Tokyo (JP)

(21) Appl. No.: 13/789,125

(22) Filed: Mar. 7, 2013

(30) Foreign Application Priority Data
May 30, 2012 (JP) 2012-123453

(51) Int. Cl. H04N 9/79

(52) U.S. Cl. CPC H04N 9/79
USPC 386/230

(57) ABSTRACT

According to one embodiment, an electronic device includes a first input, a discriminator, a display processor, a selector, and a receiver. The first input is configured to receive a first designated time. The discriminator is configured to discriminate content data, which is receivable from a recorder within the first designated time, from among a plurality of content data recorded in the recorder. The display processor is configured to display receivable content data. The selector is configured to select content data as a reception target, from the receivable content data. The receiver is configured to receive content data selected as the reception target from the recorder.

### CROSS-REFERENCE TO RELATED APPLICATIONS

This application is based upon and claims the benefit of priority from Japanese Patent Application No. 2012-123453, filed May 30, 2012, the entire contents of which are incorporated herein by reference.

### FIELD

Embodiments described herein relate generally to an electronic device which transfers data of content such as a moving picture, and a data transfer method.

### BACKGROUND

In recent years, content of television broadcast or the like, which was recorded by an HDD recorder or a television apparatus equipped with a recording function, or content, which was delivered via a network and recorded by a personal computer or the like which is connected to the network, can be transferred to a portable electronic device and can be viewed at an arbitrary location with the portable electronic device. Examples of the portable electronic device include a personal computer, a tablet PC, a mobile phone, a smartphone, and an audio player.

When content is to be transferred, a content that is a transfer target is selected by a user from among a plurality of contents recorded in the electronic device (e.g. HDD recorder, television apparatus, or personal computer). The electronic device transfers the data of the content selected by the user to a portable electronic device that is a transfer destination of the content.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating the configuration of a system according to an embodiment.

FIG. 2 is an exemplary block diagram illustrating the configuration of a recorder according to the embodiment.

FIG. 3 is an exemplary block diagram illustrating the configuration of an electronic device according to the embodiment.

FIG. 4 is a view illustrating an example of a data structure of content management data which is recorded in the electronic device of the embodiment.

FIG. 5 is a view illustrating an example of a data structure of transfer history data which is recorded in the electronic device of the embodiment.

FIG. 6 is an exemplary flowchart illustrating a content transfer process which is executed in the electronic device of the embodiment.

FIG. 7 is an exemplary flowchart illustrating the content transfer process which is executed in the electronic device of the embodiment.

FIG. 8 is a view illustrating an example of a recorder list display screen which is displayed in the electronic device of the embodiment.

FIG. 9 is a view illustrating an example of a transfer time designation screen which is displayed in the electronic device of the embodiment.

FIG. 10 is a view illustrating an example of a content select screen which is displayed in the electronic device of the embodiment.

FIG. 11 is a view illustrating an example of an updated content select screen which is displayed in the electronic device of the embodiment.

FIG. 12 is a view illustrating an example of the content select screen in the embodiment.

FIG. 13 is a view illustrating an example of a “progress in transfer” screen which is displayed in the electronic device of the embodiment.

FIG. 14 is a view illustrating an example of a display screen of a confirmation message, which is displayed in the electronic device of the embodiment.

FIG. 15 is an exemplary flowchart illustrating a content transfer process which is executed in the recorder of the embodiment.

FIG. 16 is an exemplary flowchart illustrating the content transfer process which is executed in the recorder of the embodiment.

### DETAILED DESCRIPTION

Various embodiments will be described hereinafter with reference to the accompanying drawings.

In general, according to one embodiment, an electronic device includes a first input, a discriminator, a display processor, a selector, and a receiver. The first input is configured to receive a first designated time. The discriminator is configured to discriminate content data, which is receivable from a recorder within the first designated time, from among a plurality of content data recorded in the recorder. The display processor is configured to display receivable content data. The selector is configured to select content data as a reception target, from the receivable content data. The receiver is configured to receive content data selected as the reception target from the recorder.

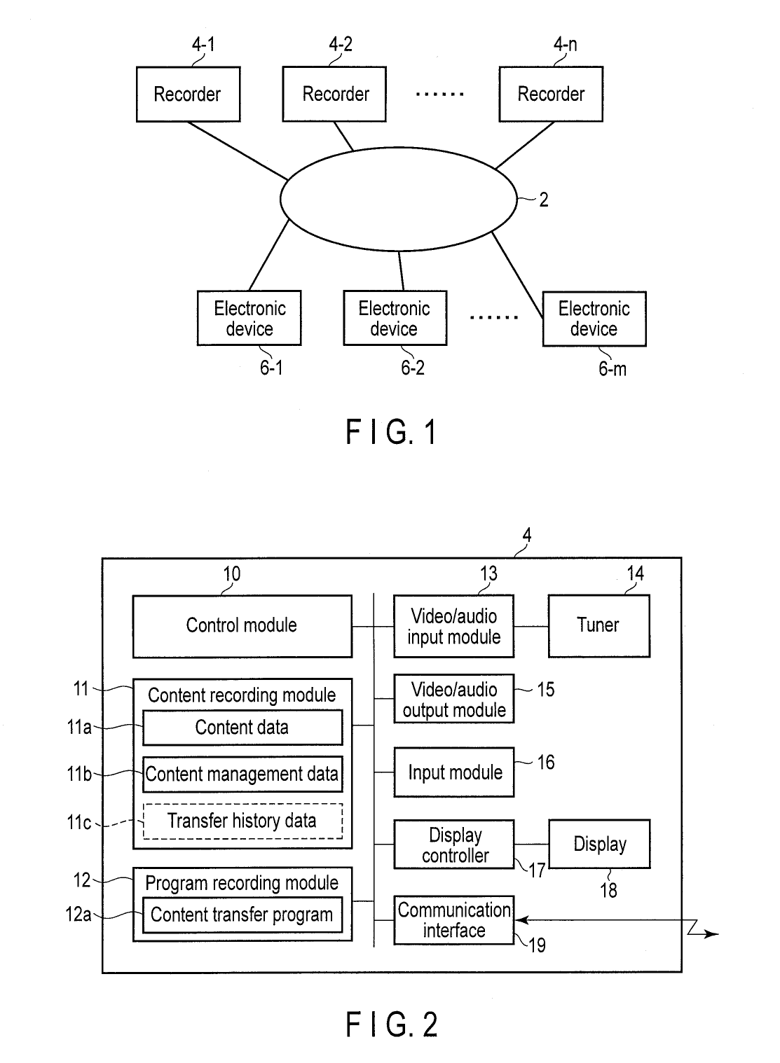

FIG. 1 is an exemplary block diagram illustrating the configuration of a system according to an embodiment. In the system of the embodiment, a specific content designated by a user is transferred from an electronic device of a content transfer source, which records various contents such as a moving picture, a still image, audio and various data files, to an electronic device of a content transfer destination, which is connected via a network. The electronic device of the content transfer source is, for instance, an HDD recorder, a television (TV) apparatus equipped with a recording function, a personal computer, or a server apparatus. The HDD or the TV apparatus with a recording function records, for example, moving picture content which is received by TV broadcast. The personal computer or server apparatus records, for example, moving picture content which is delivered via a network, still image content, or a data file. The electronic device of the content transfer source can transfer not only content, which is received from the outside by TV broadcast or network delivery, to some other electronic device, but can also transfer content, which is pre-recorded in a recording medium, to some other electronic device.

A portable electronic device, for instance, is used as the other electronic device that is the destination of content transfer. Examples of the portable electronic device include a personal computer, a tablet PC, a mobile phone, a smartphone, and an audio player.

The electronic device of the content transfer source and the electronic device of the content transfer destination are connected via a network. As the network, use may be made of various networks such as a LAN (Local Area Network), Internet, and a public switched telephone network. In addition, it is assumed that the network is capable of not only wired communication but also wireless communication.

For example, when the system in the embodiment is constructed in the home, the electronic devices of the content transfer source/destination are interconnected via a LAN. In addition, when a server apparatus which constitutes a cloud system is used as the electronic device of the content transfer source, the server apparatus is connected to the electronic device (e.g. smartphone or tablet PC) of the content transfer destination via the Internet.

In the description below, it is assumed that the electronic device which records content is a recorder 4 such as an HDD recorder, and the electronic device of the content transfer destination is an electronic device 6 such as a smartphone or a tablet PC. The recorder 4 and electronic device 6 are used, for example, in the home, and can communicate with each other via a network 2 such as a LAN. As shown in FIG. 1, in the home, a plurality of recorders 4 (4-1, 4-2, . . . , 4-n) and a plurality of electronic devices 6 (6-1, 6-2, . . . , 6-m) can be connected to the network 2 and can transmit/receive data to/from each other. In the meantime, the recorder 4 and electronic device 6 can be directly connected and can transmit/receive data to/from each other.

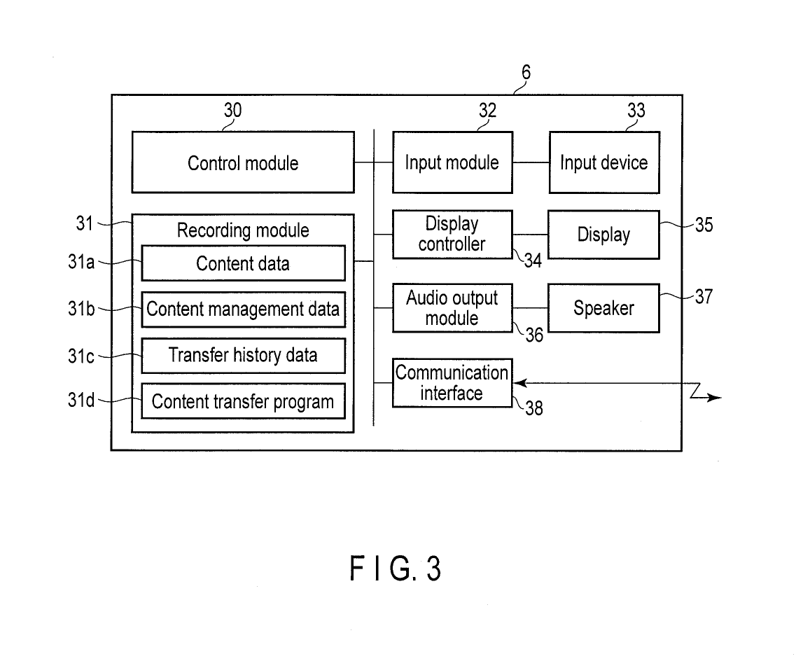

FIG. 2 is an exemplary block diagram illustrating the configuration of the recorder 4 according to the embodiment.

The recorder 4 is realized by, for example, an HDD recorder, and includes a control module 10, a content recording module 11, a program recording module 12, a video/audio input module 13, a tuner 14, a video/audio output module 15, an input module 16, a display controller 17, a display 18, and a communication interface 19.

The control module 10 is a controller which is composed of, for example, a system LSI, and the control module 10 includes a processor (CPU) and units for various image processes. The control module 10 controls various processes by executing a program which is recorded in the program recording module 12. For example, the control module 10 controls a process (recording process) of receiving various contents and recording them in the content recording module 11. In addition, the control module 10 executes a content transfer program 12a, thereby controlling a content transfer process of transferring data (content data 11a) of the content, which is recorded in the content recording module 11, to the electronic device 6.

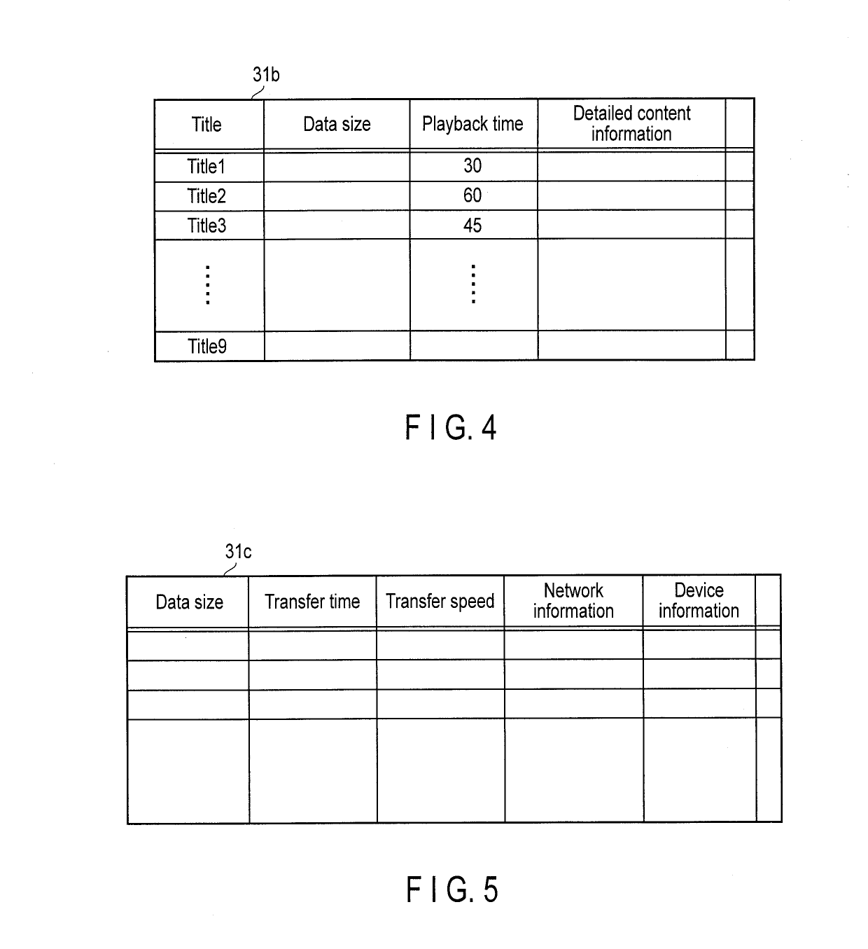

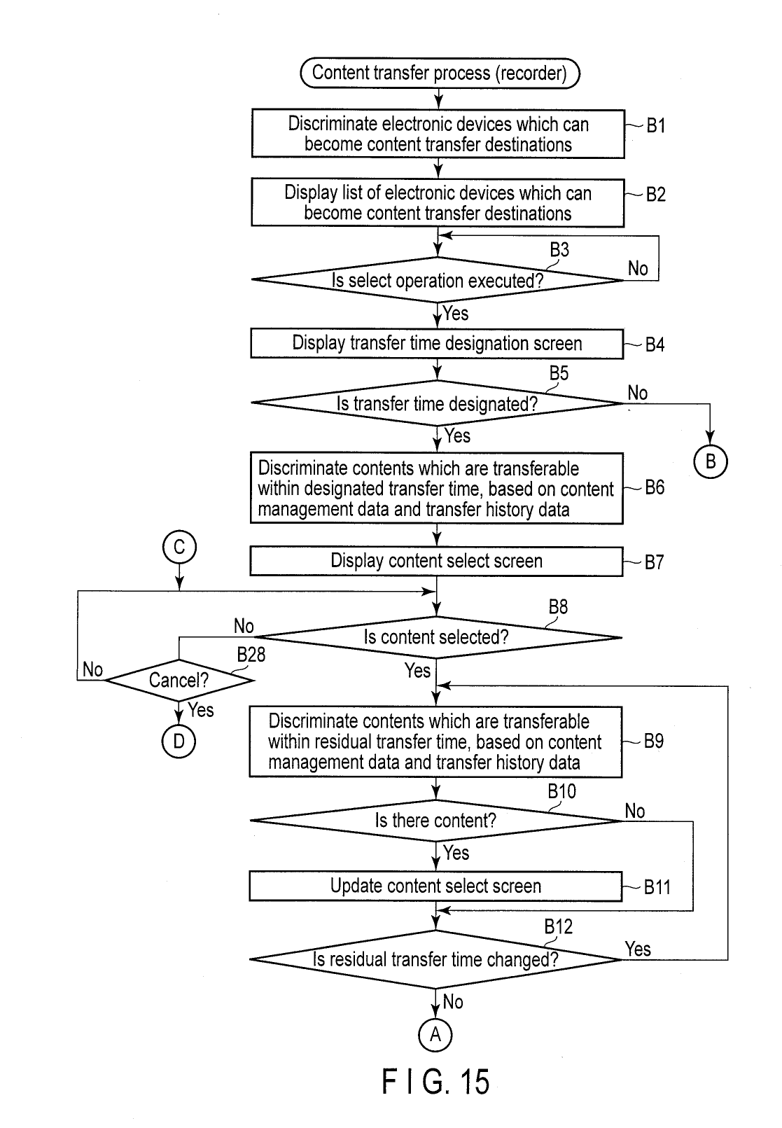

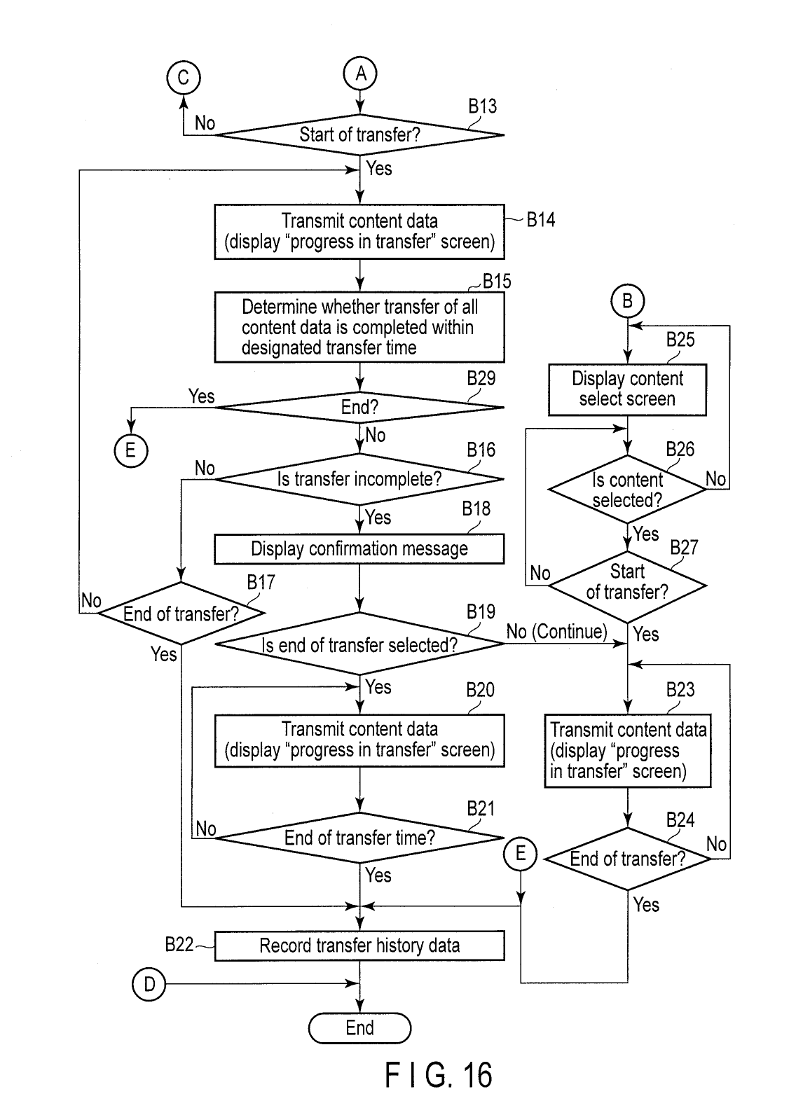

The content recording module 11 is realized by an HDD, an SSD, or an apparatus using an optical disc as a recording medium, and records content data 11a of various contents, and content management data 11b (see FIG. 4) including various data relating to contents. Content data 11a of a plurality of contents are recorded in the content recording module 11. The contents include various contents such as still images, audio, and various data files. The content management data 11b is updated in accordance with a change of recorded content, and is provided in response to a request from the electronic device 6. In the meantime, when a content transfer process, which will be described later, is executed in the recorder 4 (FIG. 15, FIG. 16), transfer history data 11c (see FIG. 5) is also recorded.

The program recording module 12 stores a basic program (OS (Operating System)) and various application programs. The application programs include the content transfer program 12a for realizing the content transfer process for transferring the content data 11a to the electronic device 6.

The video/audio input module 13 inputs a video/audio signal of TV broadcast which is received by the tuner 14, or a video/audio signal which is input over a line. The video/audio input module 13 includes units such as an A/D converter and a decoder/encoder.

The tuner 14 receives TV broadcast and outputs a video/audio signal.

The video/audio output module 15 outputs a video/audio signal of converted content data to a TV apparatus, etc. The video/audio output module 15 includes units such as an audio D/A converter and a video encoder.

The input module 16 controls an input by a user operation.

The display controller 17 controls display of the display 18.

The communication interface 19 is a controller which controls communication with other electronic devices (recorder 4, electronic device 6). The communication interface 19 transmits/receives data to/from other electronic devices via the network 2.

FIG. 3 is an exemplary block diagram illustrating the configuration of the electronic device 6 according to the embodiment.

The electronic device 6 is realized by, for example, a tablet PC, and includes a control module 30, a recording module 31, an input module 32, an input device 33, a display controller 34, a display 35, an audio output module 36, a speaker 37, and a communication interface 38.

The control module 30 includes a processor (CPU), etc., and controls various processes by executing a program which is recorded in the recording module 31. For example, the control module 30 controls a process (recording process) of receiving various contents and recording them in the recording module 31. In addition, the control module 30 executes a content transfer program 31d, thereby controlling a content transfer process of transferring data (content data 31a) of the content, which is recorded in the recording module 31, to the electronic device 6.

The recording module 31 is composed of, for example, a hard disk drive (HDD) or an SSD, and records various programs and data. The programs include a basic program (OS (Operating System)) and various application programs. The application programs include the content transfer program 31d for realizing the content transfer process of receiving the content data 11a which has been transferred from the recorder 4. The data recorded in the recording module 31 includes, in addition to the content data received from the recorder 4, content management data 31b including various data relating to the contents received from the recorder 4, and transfer history data 31c in which data relating to the reception of content data is set as a transfer history.

The input module 32 controls an input corresponding to a user operation on the input device 33. The input device 33 may be, for instance, a touch-screen display, buttons, a keyboard, or a pointing device such as a mouse.

The display controller 34 controls display of the display 35.

The audio output module 36 produces sound from the speaker 37.

The communication interface 38 is a controller which controls communication with other electronic devices (recorder 4, electronic device 6). The communication interface 38 transmits/receives data to/from other electronic devices via the network 2.

FIG. 4 is a view illustrating an example of a data structure of content management data 31b which is recorded in the electronic device 6 of the embodiment.

The content management data 31b is received from the recorder 4 that is the content transfer source. Data relating to a plurality of contents (contents which may become transfer targets), which are recorded in the recorder 4, are set in the content management data 31b. For example, as shown in FIG. 4, in the content management data 31b, title names (title 1, title 2, . . . ) of contents, data sizes of content data, playback times of contents (in the case of moving picture content), and various information (detailed content information) are associated. For example, in the case of the moving picture content of a TV program recorded in the recorder 4, the detailed content information includes the data format of content data, the date/time of broadcast of the TV program, persons appearing in the program, and a description of the program. Even when the playback times of contents are equal, if the data formats of the contents are different, the data sizes of the content data are different.

FIG. 5 is a view illustrating an example of a data structure of the transfer history data 31c which is recorded in the electronic device 6 of the embodiment.

In the transfer history data 31c, when the reception of content data from the recorder 4 has been completed, the data relating to the transfer of the content data is recorded as a transfer history.

As shown in FIG. 5, the transfer history data 31c includes the data size of the content, the transfer of which has been completed, the transfer time, the transfer speed (data size/transfer time) calculated based on the data size and transfer time, network information (e.g. wired communication, wireless communication, network path) indicative of, e.g. the environment of a network which was used for the transfer of content data, and device information of the transfer source (recorder 4) of content data.

The transfer history data 31c is referred to at a time of discriminating content data which is transferable from the recorder 4 to the electronic device 6 within a time (transfer time) designated by the user.

Next, the operation in the embodiment is described.

In the embodiment, a time needed for transfer of content data, which is allowable by the user, is set before a moving picture content (content data) such as a TV program recorded in the recorder 4 is transferred to the electronic device 6. Thereby, contents, whose content data can be completely transferred within the time designated by the user, are discriminated, and a list of the corresponding contents is displayed. The user selects a content that is a transfer target from the displayed list of contents. Thereby, the transfer of content data to the electronic device 6 can be completed within the designated time.

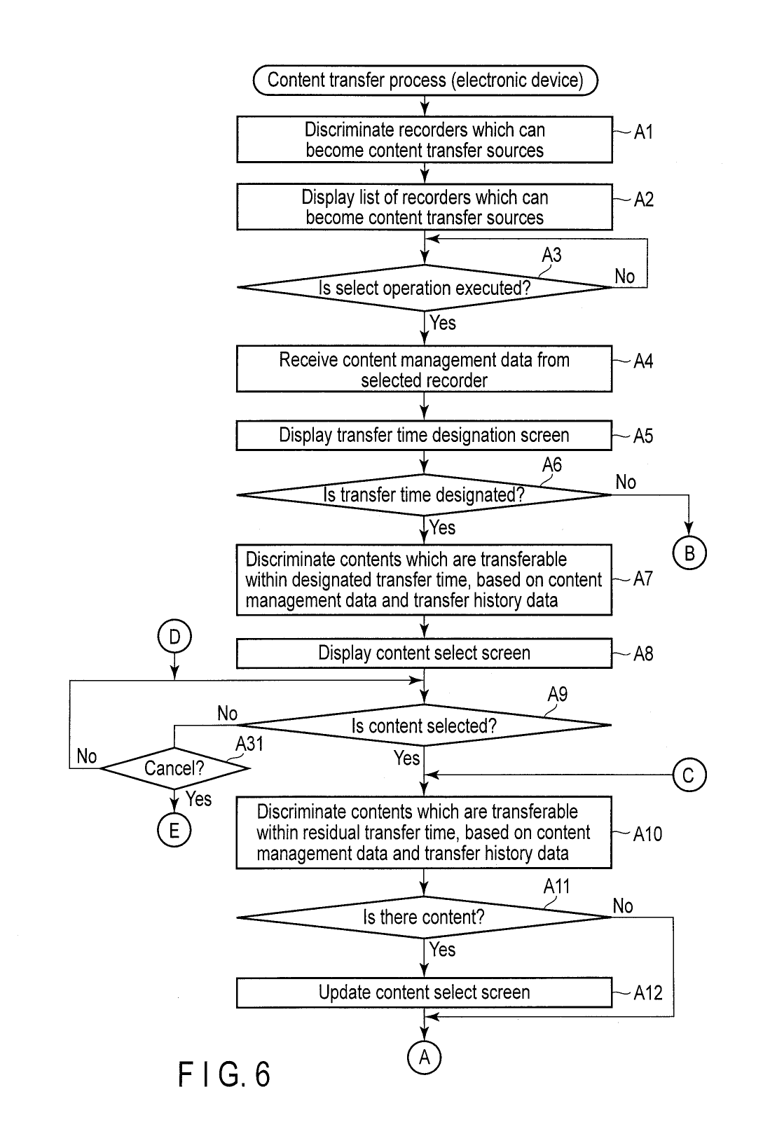

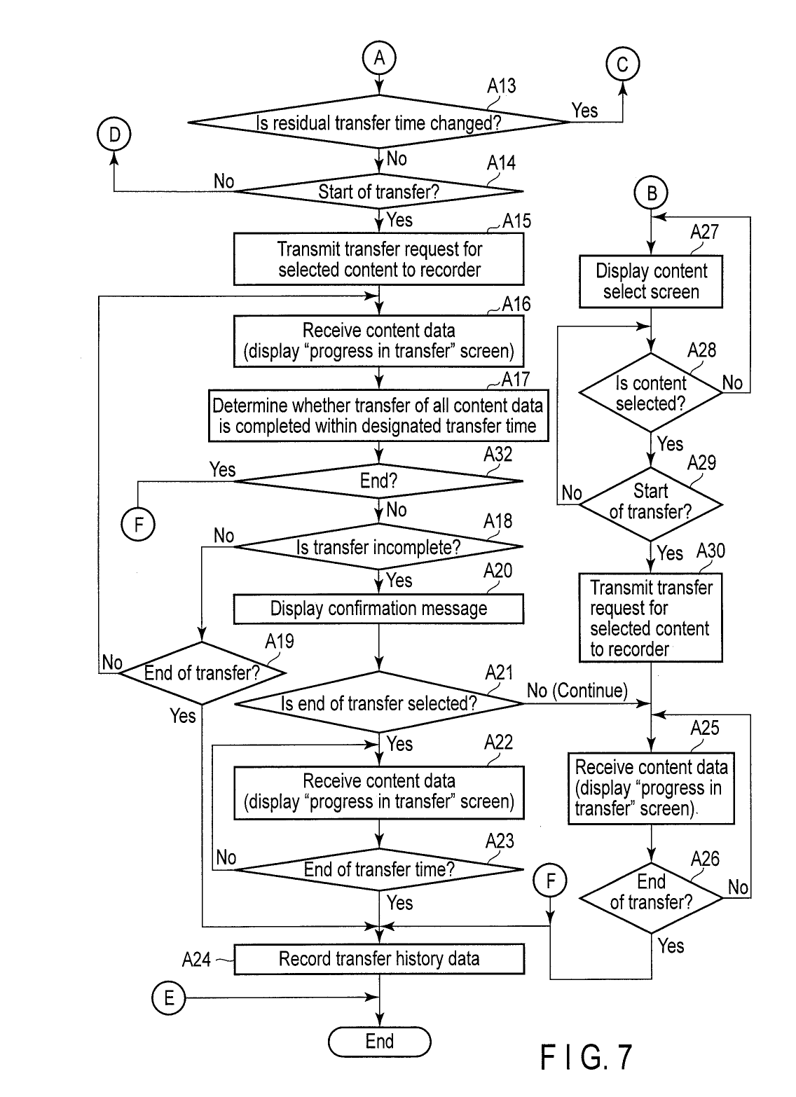

To begin with, referring to flowcharts of FIG. 6 and FIG. 7, a description is given of the case in which a content transfer process of selecting content that is a transfer target is executed in the electronic device 6. In the description below, it is assumed that the system shown in FIG. 1 is constructed in the home. The recorder 4 and electronic device 6 are connected by a LAN. The recorder 4 is an HDD recorder or a TV apparatus with a recording function. The electronic device 6 is a tablet PC, a mobile phone or a smartphone. Since the electronic device 6 is used outside the home, the electronic device 6 is not always connected to the network 2. Content data is transferred from the recorder 4 to the electronic device 6, whereby contents can be enjoyed outside the home.

If the start of the content transfer process is instructed by a user operation, the electronic device 6 starts execution of the content transfer program 31b by the control module 30. Subsequently, the control module 30 executes the process according to the content transfer program 31d.

The control module 30 discriminates recorders 4 which are connected via the network 2 and can become content transfer sources (block A1). In the recorder 4, the content transfer process by the content transfer program 12a may be always executed, or may be started in accordance with a user operation.

If the recorders 4 which are connected via the network 2 and can become content transfer sources are discriminated, the control module 30 displays a list of the discriminated recorders 4 (block A2).

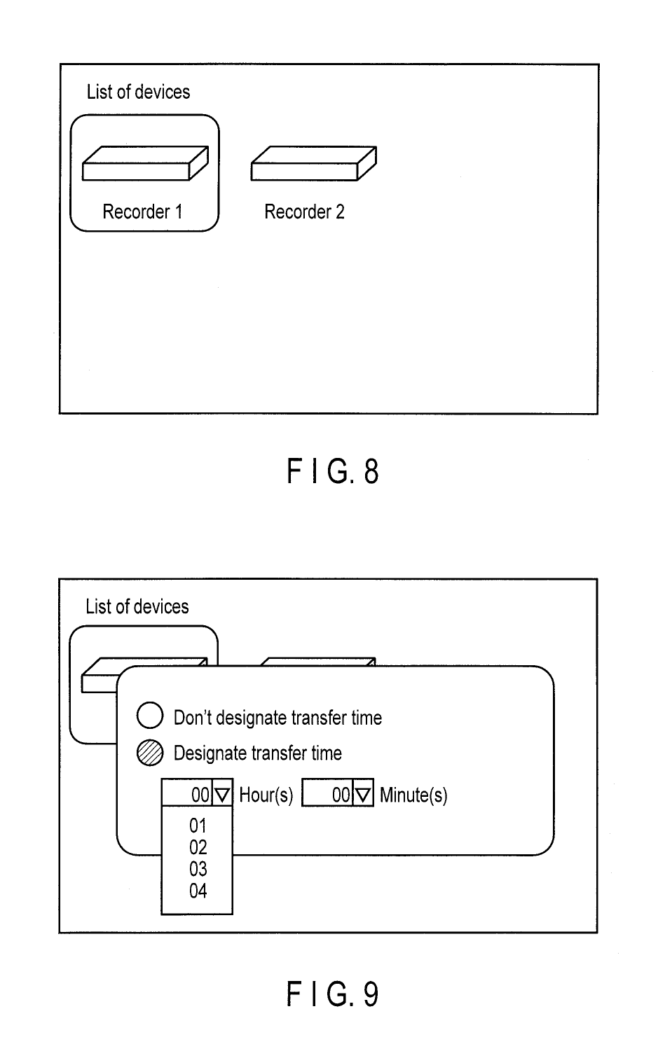

FIG. 8 is a view illustrating an example of a recorder list display screen which is displayed in the electronic device 6 of the embodiment. In FIG. 8, for example, two recorders 4 are displayed as recorders which can become content transfer sources.

If any one of the recorders is selected from the displayed list of recorders by a user's input operation on the input device 33 (Yes in block A3), the control module 30 requests the selected recorder 4 via the communication interface 38 to transmit content management data. Specifically, the control module 30 requests data relating to contents which can be transferred from the recorder 4. Responding to the transmission request from the electronic device 6, the recorder 4 transmits the content management data 11b to the electronic device 6. Upon receiving the content management data 31b from the recorder 4, the control module 30 records the content management data 31b in the recording module 31 (block A4).

Next, the control module 30 causes the display 35 to display a transfer time designation screen for setting the transfer time of content data, which is allowable by user (block A5).

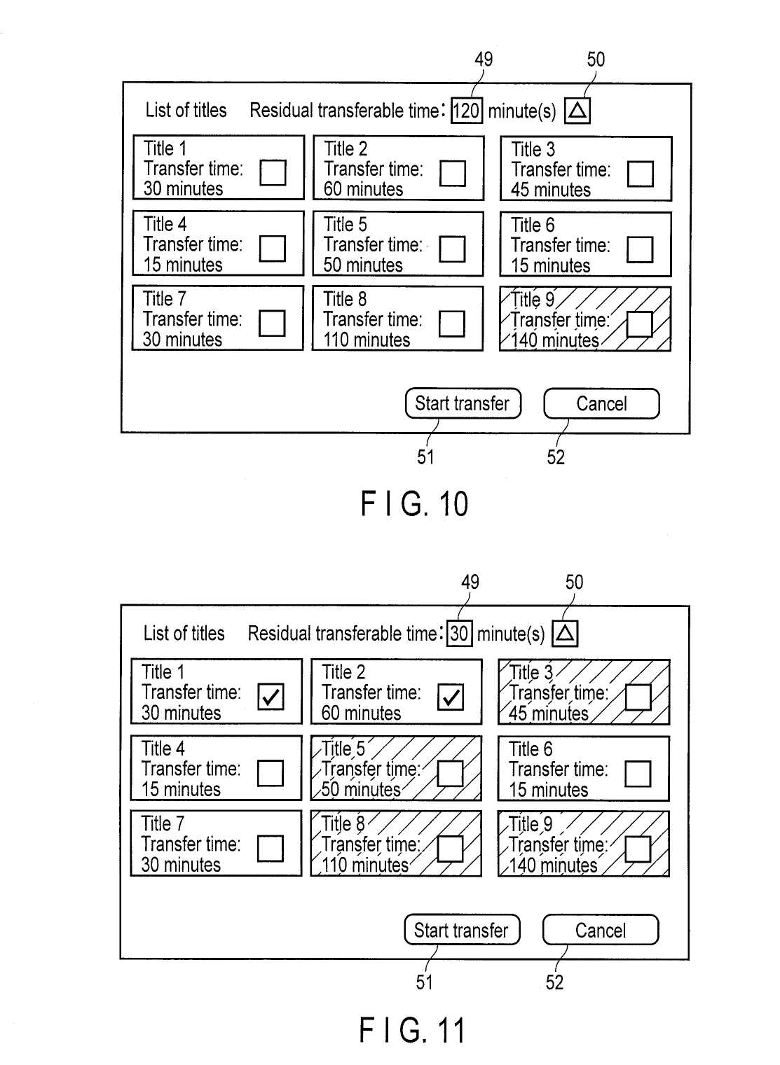

FIG. 9 illustrates an example of the transfer time designation screen which is displayed in the electronic device 6 of the embodiment.

On the transfer time designation screen shown in FIG. 9, either an item “Don't designate transfer time” or an item “Designate transfer time” can be selected by a user operation.

If the item “Don't designate transfer time” has been selected (Yes in block A6), the control module 30 executes a content transfer process of all content data of contents designated by the user, regardless of the transfer time (blocks A27 to A30, block A25, block A26). A process in the case where the transfer time has not been designated will be described later.

On the other hand, if the item “Designate transfer time” has been selected, the control module 30 accepts the designation of the transfer time of content data through the transfer time designation screen by the user operation, as shown in FIG. 9.

If the transfer time of content data is designated (Yes in block A6), the control module 30 discriminates contents which can be transferred within the designated time, based on the content management data 31b and transfer history data 31c (block A7).

For example, when data indicative of the recorder 4, which has been selected as the transfer source, is recorded as device information of the transfer history data 31c, and the environment of the network connected to the recorder 4 (e.g. wired connection or wireless connection) is recorded as the network information of the transfer history data 31c, the control module 30 acquires information of the transfer speed corresponding to the combination of the device information and the network information.

Based on the information of the transfer speed which has been acquired from the transfer history data 31c, the control module 30 calculates the time (data size/transfer speed) that is needed when the data of the data size corresponding to each content that is set in the content management data 31b is transferred. Specifically, the transfer time, which is needed when content data is transferred from the recorder 4 in the present network environment, is calculated with respect to each content.

In the above description, the information of the transfer speed, which corresponds to the combination of the network information and device information corresponding to the present condition in the transfer history data 31c, is acquired. When there are a plurality of corresponding information items, the information of the (latest) transfer speed that was last recorded may be acquired, or an average value of the corresponding transfer speeds may be calculated and acquired, or a median value, instead of the average value, may be acquired. In addition, when there is no combination of the network information and device information corresponding to the present condition in the transfer history data 31c, the transfer time of content may be calculated based on the transfer speed to which either the network information or the device information corresponds. Besides, when there is neither the network information nor the device information, which corresponds to the present condition, the transfer time may be calculated by using an average of transfer times recorded in the transfer history data 31c. In the meantime, the average of the transfer times may be calculated by using, as targets, all data recorded in the transfer history data 3c, or by using, as targets, latest plural (e.g. five) data or recent data (e.g. within a week).

The control module 30 compares the transfer time calculated with respect to each content and the transfer time designated by the user, and discriminates contents whose transfer times are shorter than the transfer time designated by the user, that is, contents which are transferable.

Based on the discriminated transferable contents, the control module 30 causes the display 35 to display a content select screen (block A8).

FIG. 10 illustrates an example of the content select screen which is displayed in the electronic device 6 of the embodiment.

The content select screen shown in FIG. 10 displays a list of all titles included in the content management data 31b. In connection with each of the titles, there are provided the title name, the transfer time calculated based on the data size, and a check box for the user to select the associated title as a transfer target.

In the example shown in FIG. 10, transferable contents are displayed in a normal display mode, and a content, which is discriminated as being not transferable, is displayed in a mode different from the normal display mode, for example, in a gray display mode, so that the user may easily recognize transferable contents. In the example shown in FIG. 10, “title 9” is displayed in a different display mode, as a content which has been discriminated as being not transferable. The “title 9” cannot be selected by the user.

In addition, on the content select screen, a residual transferable time display 49, a transferable time change button 50, a transfer start button 51, and a cancel button 52 are prepared.

The residual transferable time display 49 indicates a residual time of the transfer time designated by the user. In the initial state, the residual transferable time display 49 indicates the transfer time designated by the user. Each time a title has been selected from among the displayed list, the time, from which the transfer time of the selected time has been subtracted, is displayed. FIG. 10 illustrates that the transfer time has been set at 120 minutes (two hours) by the user. The transferable time change button 50 is a button for changing the residual transferable time which is displayed by the residual transferable time display 49. When the transferable time change button 50 has been pressed by a user operation, the transferable time displayed in the residual transferable time display 49 is increased, for example, in units of a predetermined time (e.g. 1 minute, 5 minutes). In the case where the user confirms the titles displayed in the list and there is a title which the user wishes to transfer the content thereof even by extending the transfer time, the user can change this content to a transferable content by changing (extending) the transferable time through the content select screen.

In the case where the content select screen is unable to display a list of all titles included in the content management data 31b, the screen is scrolled or the display is switched to the next page, whereby the display can be changed to a list of other titles.

The transfer start button 51 is a button for accepting the start of transfer, after at least one of the titles of the displayed list has been selected. The cancel button 52 is a button for instructing the end of the display of the content select screen.

When the cancel button 52 has been selected on the content select button (Yes in block A31), the control module 30 terminates the content transfer process.

On the other hand, if a content has been selected from the list of titles (Yes in block A9), the control module 30 adds a check mark indicative of selection to the check box of the selected content, and displays the time of the residual transferable time display 49 by subtracting the transfer time of the selected content.

In addition, based on the content management data 31b and transfer history data 31c, the control module 30 discriminates contents which can be transferred within the designated transfer time (block A10). Specifically, the control module 30 determines, in the same manner as described above, whether there is a content which can be further transferred within the residual transferable time.

If there is a transferable content (Yes in block A11), the control module 30 updates the content select screen (block A12).

FIG. 11 illustrates an example of an updated content select screen which is displayed in the electronic device 6 of the embodiment.

In the example shown in FIG. 11, “title 1” and “title 2” have been selected as transfer targets by the user operation. Since the sum of the transfer times of “title 1” and “title 2” is “90 minutes”, “90 minutes” are subtracted from the transfer time “120 minutes” (2 hours) designated by the user, and the residual transferable time “30 minutes” is displayed in the residual transferable time display 49. In addition, since “title 4”, “title 6” and “title 7” are discriminated as titles which can be transferred within the residual transferable time, titles 3, 5 and 8, other than titles 4, 6 and 7, are further displayed in gray.

On the content select screen, when the change of the residual transferable time has been designated by the user operation on the transferable time change button 50 (Yes in block A13), the control module 30 discriminates a transferable content, based on the changed transferable time, in the same manner as described above, and updates the content select screen (blocks A10 to A13).

For example, in FIG. 11, the user may change the residual transfer time to “45 minutes” by operating the transferable time change button 50, thus being able to set “title 3”, whose transfer time is 45 minutes, to be a transferable title.

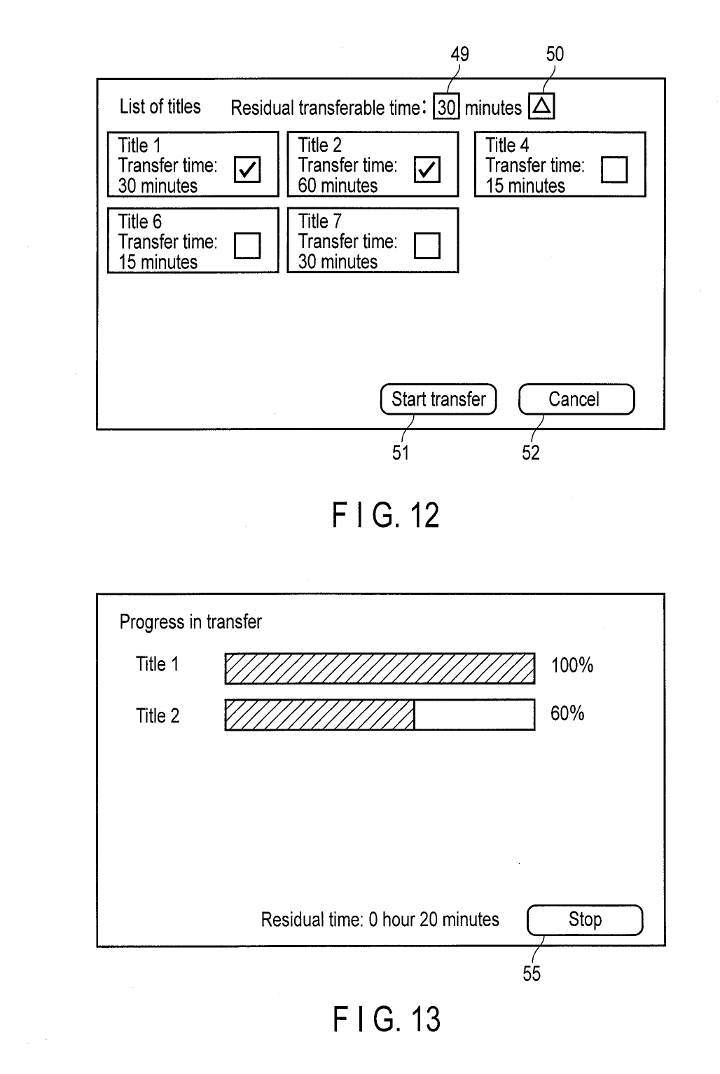

In the meantime, on the content select screen shown in FIG. 10 and FIG. 11, the transferable contents are displayed in the normal display mode, and the contents which are discriminated as non-transferable contents are displayed in a mode different from the normal display mode, for example, in a gray display mode. Alternatively, other display modes may be used. For example, as in an example of the content select screen shown in FIG. 12, only a list of titles, which are discriminated as transferable titles, is displayed. Thereby, when the user selects a transfer-target content from many titles, the user can easily perform a select operation.

If at least one content has been selected and the transfer start button 51 has been pressed (Yes in block A14), the control module 30 transmits to the recorder 4 a transfer request of the content selected on the content select screen (block A15). Responding to the transfer request of the content from the electronic device 6, the recorder 4 starts a transmission process of the content data of the requested content.

The control module 30 receives via the communication interface 38 the content data which has been transmitted from the recorder 4, and records the content data in the recording module 31 (block A16). During this time, the control module 30 causes the display 35 to display a “progress in transfer” screen indicating the progress of transfer of the content data.

FIG. 13 is a view illustrating an example of the “progress in transfer” screen which is displayed in the electronic device 6 of the embodiment.

In the example shown in FIG. 13, it is indicated that the transfer of the whole content data of “title 1” has been completed, and the transfer of “60%” of the content data of “title 2” has been completed. In addition, the “progress in transfer” screen displays a residual time of the transfer time designated by the user.

In the meantime, in the “progress in transfer” screen, a “stop” button 55 for accepting an instruction to stop the content transfer process is provided. When the “stop” button 55 has been pressed by a user operation (Yes in block A32), the control module 30 records content data, the reception of which has been completed, as a transfer-complete content. In addition, the control module 30 adds data, such as a data size of the transfer-completed content data, a transfer time, a transfer speed, network information and device information, to the transfer history data 31c as history information (block A24), and terminates the content transfer process.

Specifically, regardless of the transfer time designated by the user before starting the transfer of content data, the transfer of content data is forcibly terminated in accordance with an instruction by the “stop” button 55, and the content data, which has already been received, is saved. In the meantime, when the control module 30 forcibly terminates the transfer of the content data, the control module 30 may save content data up to a predetermined break point (e.g. a chapter) which is set in the content data, or may save all the transfer-completed content data.

The control module 30 calculates the transfer speed of data while content data is being transferred, and determines whether the transfer of all residual content data is completed at the present transfer speed (block A17). For example, depending on the present traffic of the network 2, it is possible that the present transfer speed is lower than the transfer speed (actual data of the past) recorded in the transfer history data 31c. For example, there is such a case that when content data was transferred in the past, the number of electronic devices connected to the network 2 was small and the traffic amount was small, but when content data is transferred at the present, the number of electronic devices connected to the network 2 is large and the traffic amount is large, or the processing load of the recorder 4 and electronic device 6, which transfer the content, is large, resulting in a decrease in transfer speed.

When the control module 30 determines that the transfer of all content data is completed within the designated transfer time (No in block A18), the control module 30 continues the transfer of content data (blocks A16 to A19). Then, if the transfer of all content data is completed, the control module 30 adds data, such as a data size of the transfer-completed content data, a transfer time, a transfer speed, network information and device information, to the transfer history data 31c as history information (block A24), and terminates the content transfer process. The transfer history information recorded in the transfer history data 31c is referred to in content transfer processes which will be executed subsequently.

On the other hand, while content data is being transferred, if it is determined that the transfer of all content data fails to be completed within the designated transfer time (Yes in block A18), the control module 30 causes the display 35 to display a confirmation message prompting the user to extend the transfer time (block A20). On the display screen of this confirmation message, the user can instruct extension of the transfer time of content.

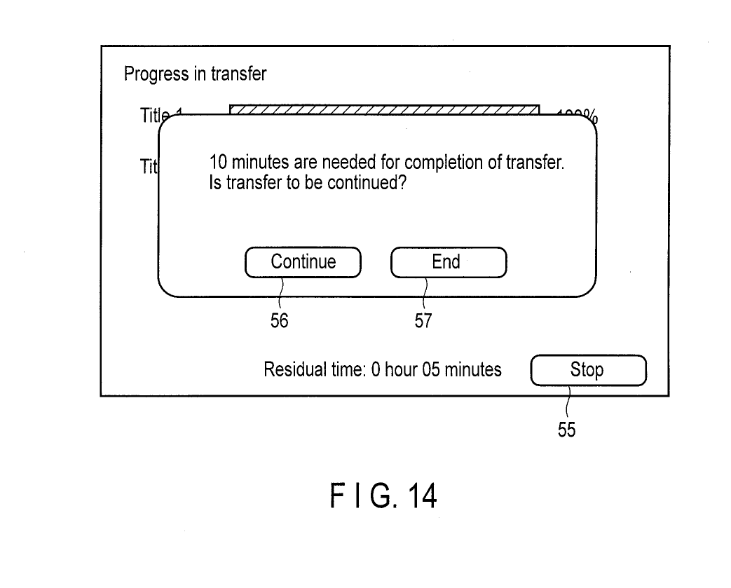

FIG. 14 is a view illustrating an example of the display screen of the confirmation message, which is displayed in the electronic device 6 of the embodiment.

In the example shown in FIG. 14, the screen displays a message “Is transfer to be continued?”, as well as a residual time up to the completion of transfer, which is calculated based on the present transfer speed and the residual data amount of content data, the transfer of which is not completed. On the display screen of the confirmation message, there are provided a “continue” button 56 for instructing the continuance of transfer until the completion of transfer of all content data, and an “end” button 57 for instructing the end of transfer at a time point when the transfer time designated by the user will expire.

When the continuance of transfer has been instructed by a user operation on the “continue” button 56 (No in block A21), the control module 30 continues receiving content data, which is transmitted from the recorder 4, via the communication interface 38 until the completion of transfer of all content data of the transfer-target content, even after the passage of the transfer time designated by the user (block A25). If the transfer of the content data is completed (Yes in block A26), the control module 30 adds data, such as a data size of the transfer-completed content data, a transfer time, a transfer speed, network information and device information, to the transfer history data 31c as history information (block A24), and terminates the content transfer process.

On the other hand, when the end of transfer has been instructed by the user operation on the “end” button 57 (Yes in block A21), the control module 30 continues receiving content data until the transfer time designated by the user expires (block A22). If the transfer time designated by the user expires, the control module 30 records the content data, the reception of which has been completed up to the end of the transfer time, as a transfer-complete content. In addition, the control module 30 adds data, such as a data size of the transfer-completed content data, a transfer time, a transfer speed, network information and device information, to the transfer history data 31c as history information (block A24), and terminates the content transfer process. In this case, the control module 30 saves the content data up to a predetermined break point (e.g. a chapter) which is set in the content data, or saves all the transfer-completed content data. Specifically, even when the transfer of all content data is not completed, the transfer of most of the contents has been completed since the contents selected from the content select screen are set as transfer targets, based on the transfer time which was designated in advance by the user. Thus, there occurs no serious problem when the contents are viewed by using the electronic device 6. Therefore, the process can be terminated by the transfer time designated by the user, and the transfer of most of contents can be completed.

In this manner, in the electronic device 6 in the embodiment, in the content transfer process, the content data can be transferred in accordance with the transfer time designated by the user, that is, in accordance with the time that is needed for the transfer of control data and is allowable by the user. In the present embodiment, on the content select screen, contents, which are transferable within the transfer time designated by the user, can be selected by a simple operation. In addition, on the content select screen, the transfer time can be changed (extended) by an operation on the transferable time change button 50, and the number of contents, which are selectable as transfer targets, can be increased. Moreover, while content data is being transferred, if such a situation occurs that the transfer of all content data is not completed, the continuance of transfer until the completion of transfer can be instructed by an operation on the “continue” button 56 through the “progress in transfer” screen. Specifically, even after the transfer of content data is started, the time that is allowable by the user can be changed and the transfer of content data can be completed. Besides, even when the transfer of all content data is not completed, since the transfer-completed content data is saved, the transfer-completed content can be viewed by the electronic device 6.

In the above description, the case in which a transfer-target content is selected in the electronic device 6 has been described by way of example. Alternatively, the content transfer process can be executed in the recorder 4 that is the transfer source of content data, in the same manner as described above.

FIG. 15 and FIG. 16 are exemplary flowcharts illustrating the case of executing the content transfer process of selecting a transfer-target content in the recorder 4. Basically, the process is executed like the flowcharts of FIG. 6 and FIG. 7.

When the recorder 4 is, for instance, an HDD recorder, video signals for displaying various screens shown in FIG. 8 to FIG. 11 can be output to, e.g. a TV apparatus via the video/audio output module 15, and such screens can be displayed.

The control module 10 of the recorder 4 discriminates electronic devices 6 which are connected via the network 2 and can become content transfer destinations (block B1), and displays a list of the discriminated electronic devices 6 (block B2).

If any one of the electronic devices 6 is selected from the displayed list of electronic devices in accordance with an instruction from the user, which is input through the input module 16 (Yes in block B3), the control module 10 executes a process for transmitting content data to the selected electronic device 6.

Steps B4 to B13, and B14 to B29 in FIG. 15 and FIG. 16 execute processes similar to those in blocks A5 to A14, and A16 to A32, and a detailed description thereof is omitted.

In this manner, by executing the content transfer process in the recorder 4 that is the transmission source of content data, it is possible to obtain the same advantageous effects as in the case of executing the content transfer process in the electronic device 6.

In the above description, the content transfer process is executed in a predetermined one of the electronic device 6 and the recorder 4. Alternatively, one of the electronic device 6 and the recorder 4, which are connected via the network 2 in such a state that contents can be transferred therebetween, may be selected by the user, and the content transfer process may be executed.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The process that has been described in connection with the above embodiment may be stored as a computer-executable program in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the computer is controlled by the program, thereby executing the above-described process.

What is claimed is:

1. An electronic device comprising:
a first input configured to receive a first designated time;
a discriminator configured to discriminate content data, which is receivable from a recorder within the first designated time, from among a plurality of content data recorded in the recorder;
a display processor configured to display receivable content data;
a selector configured to select content data as a reception target, from the receivable content data; and
a receiver configured to receive content data selected as the reception target from the recorder.

2. The electronic device of claim 1, further comprising:
a message display configured to display a message when the reception of the content data is not completed by the receiver within the first designated time; and
a second input configured to receive an instruction to extend the first designated time after the message is displayed.

3. The electronic device of claim 2, further comprising a recording module configured to record content data received within the first designated time, when the instruction to terminate the reception of the content data is received after the message is displayed,
wherein the receiver is configured to terminate the reception of the content data when the first designated time has passed.

4. The electronic device of claim 1, further comprising a third input configured to receive a change instruction to change the first designated time to a second designated time,
wherein the discriminator is configured to discriminate content data, which is receivable by the receiver within the second designated time.

5. The electronic device of claim 1, further comprising a history recording module configured to record history data relating to the reception of the content data, when the reception of the content data is completed by the receiver,
wherein the discriminator is configured to discriminate content data, which is receivable within the first designated time, based on the history data.

6. An electronic device comprising:
an input configured to receive a designated time;
a discriminator configured to discriminate content data, which is transferable to an external electronic device within the designated time, from among a plurality of content data;
a display processor configured to display the transferable content data;
a selector configured to select content data as a transfer target, from the transferable content data displayed; and
a transmitter configured to transfer the content data as the transfer target to the external electronic device.

7. A data transfer method of transferring content data, which is recorded in a first electronic device, to a second electronic device, comprising:
inputting a designated time;
discriminating content data, which is transferable to the second electronic device within the designated time, from among a plurality of content data recorded in the first electronic device;
displaying the transferable content data; and
selecting content data as a transfer target, from the transferable content data.

8. A non-transitory computer-readable medium having stored thereon a computer program which is executable by a computer, the computer program controlling the computer to execute functions of:
inputting a designated time;
discriminating content data, which is receivable from a recorder within the designated time, from among a plurality of content data recorded in the recorder;
displaying the receivable content data;
selecting content data as a reception target, from the receivable content data; and
receiving the content data as the reception target from the recorder.
